(19) United States
(12) Patent Application Publication
(10) Pub. No.: US 2018/0137297 A1
(43) Pub. Date: May 17, 2018

(54) SECURITY SYSTEM FOR INDUSTRIAL CONTROL SYSTEM

(71) Applicant: Schneider Electric Industries SAS, Rueil Malmaison (FR)

(72) Inventor: Zakarya DRIAS, Nice (FR)

(73) Assignee: Schneider Electric Industries SAS, Rueil Malmaison (FR)

(21) Appl. No.: 15/574,282

(22) PCT Filed: Jun. 3, 2016
(86) PCT No.: PCT/EP2016/062618

§ 371 Date: Nov. 15, 2017

(30) Foreign Application Priority Data
Jun. 26, 2015 (FR) 1555952

(51) Int. Cl. G06F 21/62; G06F 21/41; H04L 29/06; H04L 9/32; H04L 9/08

(52) U.S. Cl. CPC G06F 21/6218; G06F 21/41; H04L 63/0815; H04L 63/10; G05B 19/418; H04L 9/3213; H04L 9/0861; H04L 9/0894; H04L 63/0823

(57) ABSTRACT

A security system for an industrial control system that includes one or more hardware entities and/or one or more software entities accessible by at least one user via at least one security portal, the security system including: a security database: and a security server. Each hardware or software entity includes a software agent including: a module for verifying each security token received coming from a security portal or from a hardware or software entity, a module for analyzing access rights of the user, of another software entity or hardware entity, and a module receiving security tokens configured to transfer a token to a second hardware or software entity to which a security portal or another entity wishes to gain access.

### TECHNICAL FIELD OF THE INVENTION

The present invention relates to a security system for an industrial control system.

### PRIOR ART

An industrial control system (or ICS) generally denotes a control system employed in the industrial field and including supervision solutions of the SCADA type, distributed control solutions (DCS for “Distributed control systems”) or any other solution including notably one or more Programmable Logic Controllers (or PLC). An industrial control system is notably designed to configure, supervise and manage critical infrastructures such as for example those linked to an electrical power station, a nuclear power station, a water treatment plant, mineral or gas extraction solutions, a pharmaceutical or chemical fabrication process. The system thus comprises one or more hardware entities and/or software entities installed and accessible via one or more security portals. A hardware entity may be a programmable logic controller (PLC), a sensor, an actuator, etc. A software entity is for example a software application implemented for configuring, managing, controlling or supervising the system and one or more of its hardware entities defined hereinabove.

In view of the critical aspect of the infrastructures described hereinabove, data processing security has become a key challenge for protecting the system from any malicious intrusion.

Today, the security of each hardware entity or software entity of the system is managed independently such that a user has to log on each time supplying identity data (for example Login and password) and justifying specific access rights, whether they wish to access a particular hardware entity or software entity of the industrial control system.

The document WO2006/059195A1 describes a secure energy management architecture comprising several smart electronic devices connected together.

The aim of the invention is to provide a security system for an industrial control system allowing a user to avoid logging on each time that they wish to gain access to a hardware entity and/or a software entity of the industrial control system. The solution of the invention allows the management of the identity data for each user or hardware entity of the system, originator of an action in the system, together with the control of access to the resources of the various entities of the system.

This aim is achieved by a security system for an industrial control system that comprises one or more hardware entities and/or one or more software entities accessible by at least one user via at least one security portal, the security system comprising:
a security database configured for storing:
   identity data associated with each user and hardware entity,
   data for access rights to each hardware entity or software entity of the system,
   security tokens generated for each user and each hardware entity, each security token comprising the data signed by a security server and relating to the identity of the user or of the hardware entity and the access rights data assigned to the user or to the hardware entity,
a security server comprising:
   a module for verifying identity data for a user or for a hardware entity in the security database,
   a module for generating security tokens for each user or hardware entity identified in the security database,
   a module for managing the identity data for each user or hardware entity stored in the security database,
   a module for managing the access rights data stored in the security database,
Each hardware entity or software entity comprises a software agent comprising:
   a module for verifying each security token received coming from a security portal, from a software entity or from another hardware entity,
   a module for analyzing access rights of the user, of another software entity or of another hardware entity,
   a module for receiving security tokens configured for receiving and storing each token received and for signing the security token received from a security portal or from a first hardware entity and for transferring this signed token to a second hardware or software entity to which the security portal or the first hardware entity wishes to gain access.

According to one feature, each software agent comprises a module for managing cryptographic keys configured for the generation, the exchange, the storage, the use and the replacement of cryptographic keys needed to sign a security token or to decrypt it.

According to another feature, each software agent comprises one or more cryptographic libraries.

According to another feature, the software agent of a hardware entity comprises an authentication module configured for sending the identity of the hardware entity to the security server in order to receive a security token from it.

### BRIEF DESCRIPTION OF THE FIGURES

Other features and advantages will become apparent from the detailed description that follows presented with regard to the appended drawings in which:

FIG. 1 shows, schematically, the architecture of the security system of the invention employed in order to render an industrial control system secure,

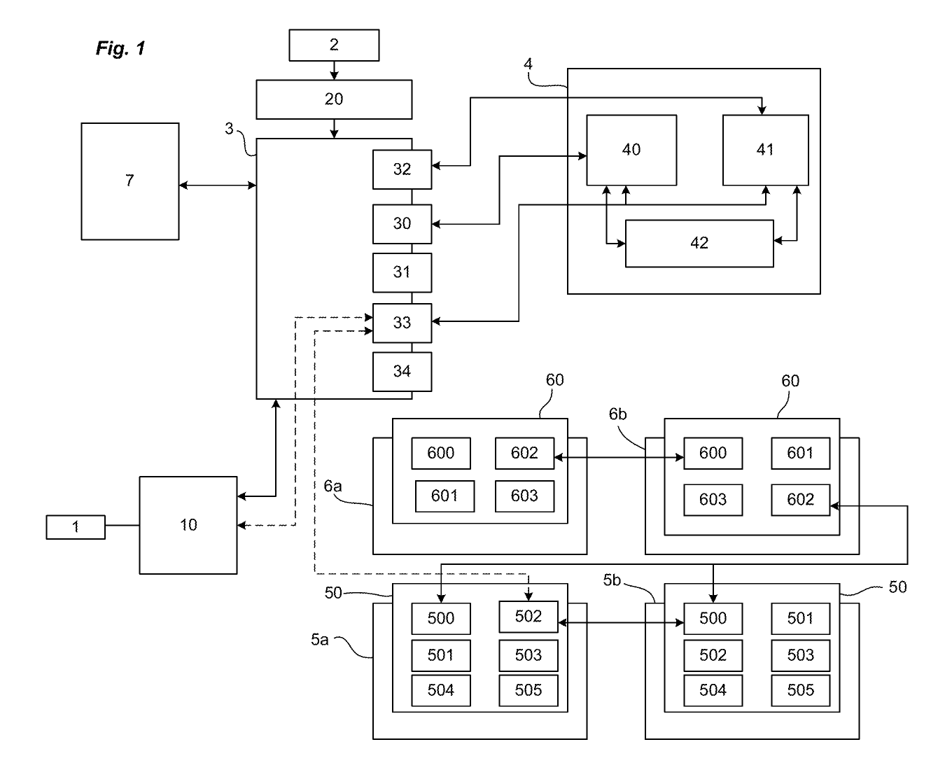

FIG. 2 illustrates the procedure for registering a user and for adding a hardware entity in the security system of the invention,

FIG. 3 illustrates the procedure for enrolling a hardware entity and for authenticating this entity,

FIG. 4 illustrates the procedure for authenticating a user and for accessing a software entity by a user,

FIG. 5 illustrates the procedure for a user to access a hardware entity via a software entity,

FIG. 6 illustrates the procedure for one hardware entity to access another hardware entity,

FIG. 7 illustrates the procedure for updating a security token,

FIGS. 8A and 8B shows two separate architectures of a security token.

### DETAILED DESCRIPTION OF AT LEAST ONE EMBODIMENT

As described hereinabove, an industrial control system is for example designed to manage a critical infrastructure and comprises one or more hardware entities and/or one or more software entities. A hardware entity is for example a programmable logic controller, a sensor, an actuator, etc. A software entity is for example designed to manage the configuration and/or the operation of one or more hardware entities of the system.

Depending on the configuration of the system, several cases of interaction between user, hardware entity 5 and software entity 6 may arise:
the user 1 may be connected to a hardware entity 5 or a software entity 5 of the system via a security portal 10,
a hardware entity 5a or a software entity 6a may be connected to another hardware entity 5b or to another software entity 6b.

Each of these operational cases will be described hereinbelow, in relation to the security system of the invention.

The security system of the invention principally comprises the following elements:
a security database 4,
a security server 3,
software agents 50, 60 each associated with a hardware entity 5 or with a particular software entity 6.

The security database 4 is designed to store various types of security data:
authentication data 40,
authorization data 41,
data 42 linked to the security policy implemented for the system.

In the authentication data 40, can be found:
for each user, an identifier, a password and a security token,
for each hardware entity, an identifier, a certificate and a security token.

In the authorization data 41, can be found:
for each hardware entity and software entity of the system, data linked to their access rights to each hardware entity and to each software entity of the system.

In the data 42 linked to the security policy, can be found:
for each user 1 and hardware entity 5 of the system, a file in a suitable format, for example XACML (for eXtensible Access Control Markup Language), for summarizing the authorizations associated with each user 1 or hardware entity 5 of the system, together with a copy of the associated security token.

For each user 1 and hardware entity 5 of the system, the security token corresponds to the XACML file described hereinabove, date stamped and signed by the security server 3.

The security server 3 is intended notably to manage the authentication of each user 1 and each hardware entity 5 of the system. It thus comprises:
a module 30 for managing the authentication data of each user 1, stored in the security database 4, intended to verify the authentication data of each user,
a module 31 for managing the authentication data of each hardware entity 5 of the system, stored in the security database 4, intended to verify the certificate of each hardware entity,
a module 32 for managing the data linked to the access rights of each user 1 and each hardware entity 5 of the system, stored in the security database 4,
a module 33 for managing the security tokens assigned to each user and each hardware entity of the system, notably for carrying out the signature and the date stamping upon the generation of each security token,
an administrator interface 34 notably allowing an administrator, by means of an administration software tool, to register new users and new hardware entities, to input the access rights to the various hardware entities and software entities of the system, together with the configuration and the assignment of the access rights to each user and each hardware entity.

Each hardware entity 5 comprises a software agent 50 whose responsibility is to manage all the security operations linked to the hardware entity with which it is associated. For a hardware entity 5, such a software agent 50 comprises:
a module 500 for verification of each security token received coming from a security portal 10, from a software entity 6 or from another hardware entity 5,
a module 501 for analyzing the access rights of the user 1, of a software entity 6 or of another hardware entity 5 after decryption and reading of a received security token,
a module 502 for receiving security tokens configured for receiving and storing each token received and for signing the security token received from a security portal 10 or from a first entity and for transferring this signed token to a second entity to which the security portal 10 or the first entity wishes to gain access,
a module 503 for managing cryptographic keys configured for the generation, the exchange, the storage, the use and the replacement of cryptographic keys,
one or more cryptographic libraries 504 such as for example OpenSSL,
an authentication module 505 configured for sending the identity (certificate) of the hardware entity to the security server 3 in order to receive a security token from it.

Each software entity 6 also comprises a software agent 60 whose responsibility is to manage all the security operations linked to the software entity 6 with which it is associated. This agent comprises:
a module 600 for verification of each security token received coming from a security portal, from a hardware entity or from another software entity,
a module 601 for analyzing access rights of the user, of a hardware entity or of another software entity after decryption and reading of a security token received,
a module 602 for receiving security tokens configured for receiving and storing each token received and for signing the security token received from a security portal or from a first entity and for transferring this signed token to a second entity to which the security portal or the first entity wishes to gain access,
one or more cryptographic libraries 603 such as for example OpenSSL.

In each hardware entity 5 or software entity 6 of the system, the module 501, 601 for analyzing the access rights analyzes the architecture of the XACML file which comprises a point for application of the decision (known as a “Policy Enforcement Point” or PEP) and a point for deciding the policy (known as a “Policy Decision Point” or PDP).

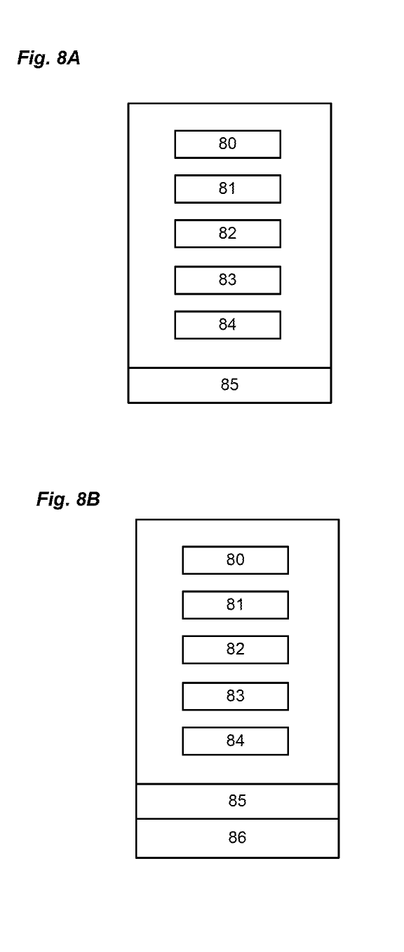

FIGS. 8A and 8B show the architecture of a security token, respectively when the latter is generated by the security server and when the latter is transmitted by a software agent.

In FIG. 8A, the security token transmitted by the security server is a file which comprises the following data:
date stamp data 80 for specifying the date of creation of the file,
the duration of validity 81 of the security token,
identity data 82 on the user 1 or on the hardware entity 5 associated with the security token,
data 83 identifying the body having generated the file,
the data 84 linked to the access rights of the user 1 or of the hardware entity 5 in question,

This file is signed (signature 85) by the security server 3 with the aid of a private key in order to generate the security token.

In FIG. 8B, the security token transmitted by a software agent 50, 60 of a hardware entity 5 or of a software entity 6, consists of the security token described hereinabove which is furthermore signed (signature 86) by the software agent 50, 60 in order to be able to be authenticated by the receiver.

The security system may comprise a certification authority 7 whose role is notably to provide the certificates for each hardware and software entity of the system. The certification authority interacts with the security server to supply, upon request from the security server, each certificate associated with a hardware and software entity of the system. The certificates are stored in a database managed by the certification authority. The certification authority 7 also disposes of means for generating new certificates and for verifying whether the certificates of each hardware and software entity are up to date.

In order to encrypt the data exchanged, the security system of the invention uses a conventional encryption system based on a public key and private key mechanism, for example TLS/SSL.

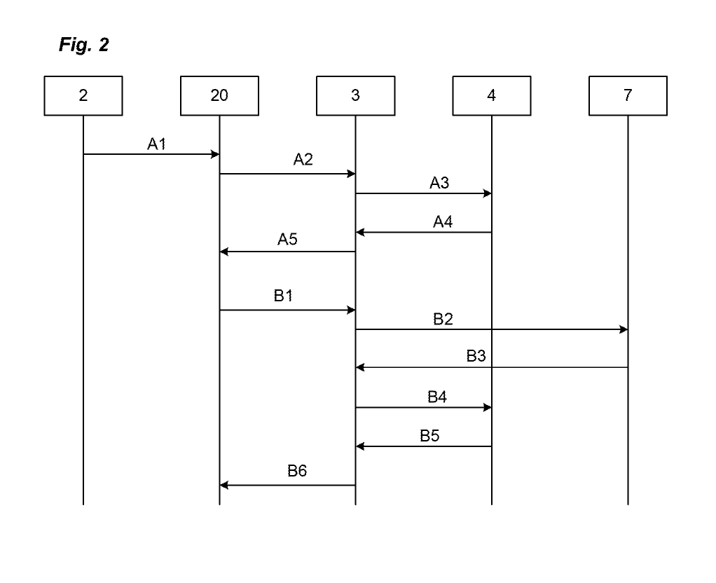

FIG. 2 illustrates the principle for registering a user 1 and a hardware entity 5 of a system by an administrator 2 connected to the security server via the administration software tool 20 executed on a computer terminal. For any administration task, the administrator 2 must first of all identify themselves (A1) to the security server 3 via the administration software tool 20. In order to add a user 1, the procedure uses the following steps:
A2: the administrator 2 sends a request to add a user 1 to the security server 3, accompanied by data for identification of the user 1,
A3: the security server 3 sends a command to write the identification data relating to the user 1 in the security database 4,
A4: the security database 4 confirms to the security server 3 the addition of the user 1,
A5: the security server 3 confirms the addition of the user in the security database 4.

For the addition of a hardware entity 5, the procedure comprises the following steps:
B1: via the administration software tool 20, the administrator 2 sends a request to add a hardware entity 5 to the security server 3,
B2: the security server 3 sends a request to the certification authority 7 with the aim of obtaining the certificate of the hardware entity 5 to be registered,
B3: the certification authority 7 sends back the requested certificate,
B4: the security server 3 sends a command to write the identification data, notably the certificate obtained, linked to the hardware entity 5 in the security database 4,
B5: the security database 4 confirms the registration of the hardware entity,
B6: the security server confirms the addition of the hardware entity to the administrator.

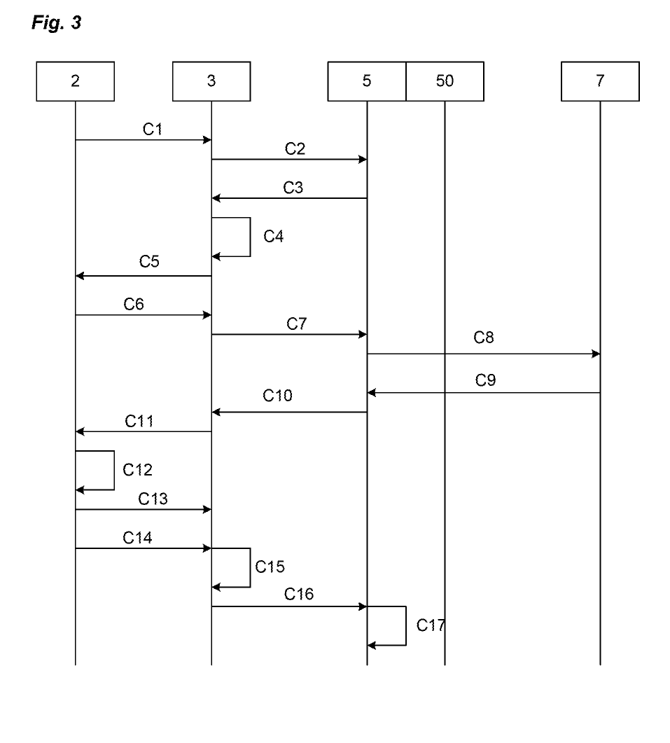

FIG. 3 illustrates the procedure for enrolling a hardware entity 5 and its authentication:
C1: via the administrator interface of the security server 3, the administrator 1 launches a command of the “Discover” type from the security server with a view to determining the hardware entities of the system,
C2: the security server 3 sends a request for a certificate to the software agent 50 of a hardware entity 5 of the system,
C3: the authentication module 505 of the software agent 50 of the hardware entity 5 responds to the request by sending its certificate,
C4: the security server 3 verifies the certificate of the hardware entity 5,
if the certificate is valid:
   C5: the hardware entity 5 is authenticated.
if the certificate is not valid:
   C6: the administrator 2 sends a request to add the hardware entity 5 to the security server 3,
   C7: the security server 3 sends an enrolment request to the authentication module of the software agent 50 of the hardware entity with the address of the certification authority 7 with a view to obtaining a certificate from the certification authority 7,
   C8: the software agent 50 of the hardware entity 5 sends a request to the certification authority 7, for example in the form of a request based on the SCEP protocol (“Simple Certificate Enrolment Protocol”), with a view to obtaining a valid certificate,
   C9: the certification authority 7 generates a certificate for the hardware entity 5 and responds to the request by sending the certificate to the software agent 50 of the hardware entity 5,
   C10: the authentication module of the software agent 50 of the hardware entity 5 sends the certificate obtained on to the security server 3,
   C11: the security server 3 validates the authentication of the hardware entity 5 to the administrator 2.
C12: using the administration software tool 20, the administrator 2 inputs the configuration data for the hardware entity 5, notably the data linked to the access rights of this hardware entity,
C13: the administrator 2 sends a request to register the configuration data of the hardware entity for the attention of the security server 3 with a view to creating the XACML file for the hardware entity 5,
C14: the administrator subsequently sends a request to the security server for the generation of the security token,
C15: the security server 3 generates the security token by virtue of its management module,
C16: the security server 3 distributes the security token to the hardware entity,
C17: the receiver module of the hardware entity stores the token received.

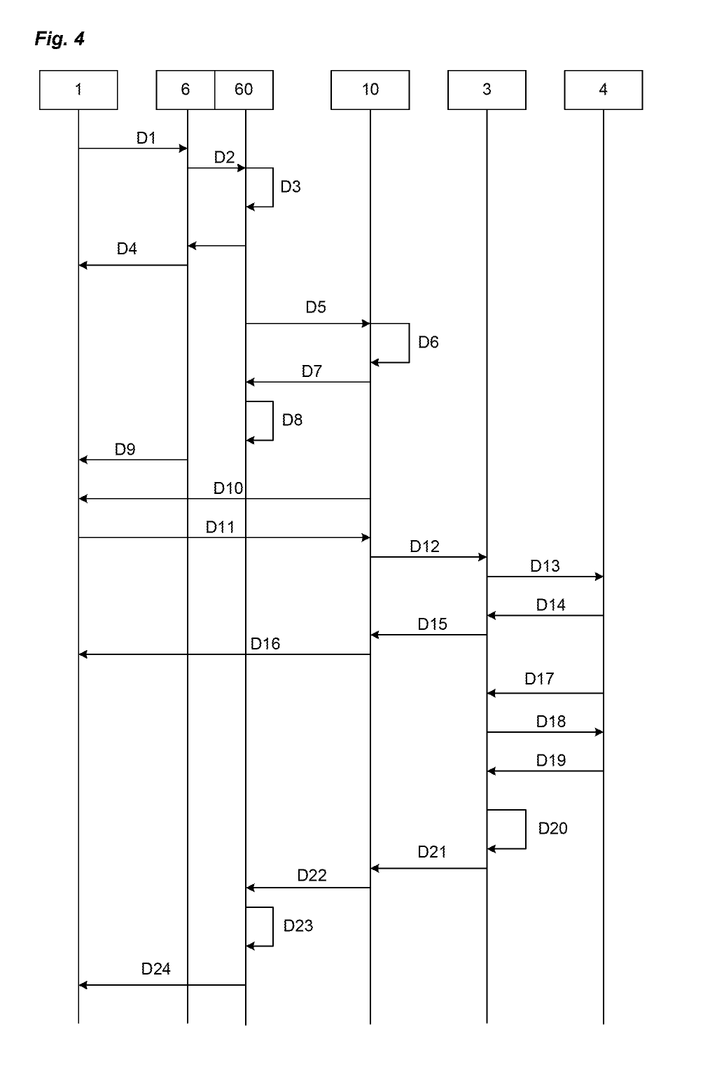

FIG. 4 illustrates the procedure for a user to access a software entity. This procedure comprises the following steps:
D1: the user 1 launches a software entity 6 of the system,
D2: the software entity 6 requests its software agent 60 to authenticate this user 1 and to verify their access rights,
D3: by means of its verification module, the software agent 60 verifies the security token of the user 1,
if the security token is valid:
   D4: the software entity is executed.
if the security token is not valid:
   D5: the software agent sends a request for the attention of the security portal with a view to obtaining the current security token associated with the user,
      D6: if the security portal holds a security token for this user:
         D7: the security portal sends the security token to the software agent of the software entity,
         D8: the verification module of the agent of the software entity verifies the security token received for authentication,
         D8: the analysis module of the software agent of the software entity verifies the access rights of the user,
         D9: if the user is authenticated and their access rights validated, the software entity is executed,
      if the security portal does not hold a token:
         D10: the security portal requests the user to provide their identity data (identifier, password),
         D11: the user provides their identity data,
         D12: the security portal sends a request for the attention of the security server with a view to obtaining a security token by sending the identity data for the user,
         D13: the security server verifies the identity data received to the security database:
         D14: if the identity data is not stored in the security database:
         D15: the security server sends a negative response to the security portal,
         D16: the authentication procedure has failed.
         D17: if the identity data is stored in the security database:
         D18: the security server sends a request to the security database with a view to obtaining the data linked to the access rights of the user, in other words the XACML file associated with this user,
         D19: the security database 4 sends back the data linked to the access rights of the user in the form of the XACML file,
         D20: based on the XACML file received, the security server generates the security token,
         D21: the security server sends the security token generated to the security portal,
         D22: the security portal transfers the security token to the software agent of the software entity,
         D23: the verification module of the agent of the software entity verifies the security token received for authentication of the user and verification of their access rights,
         D24: if the user 1 is authenticated and their access rights validated, the software entity 6 is executed.

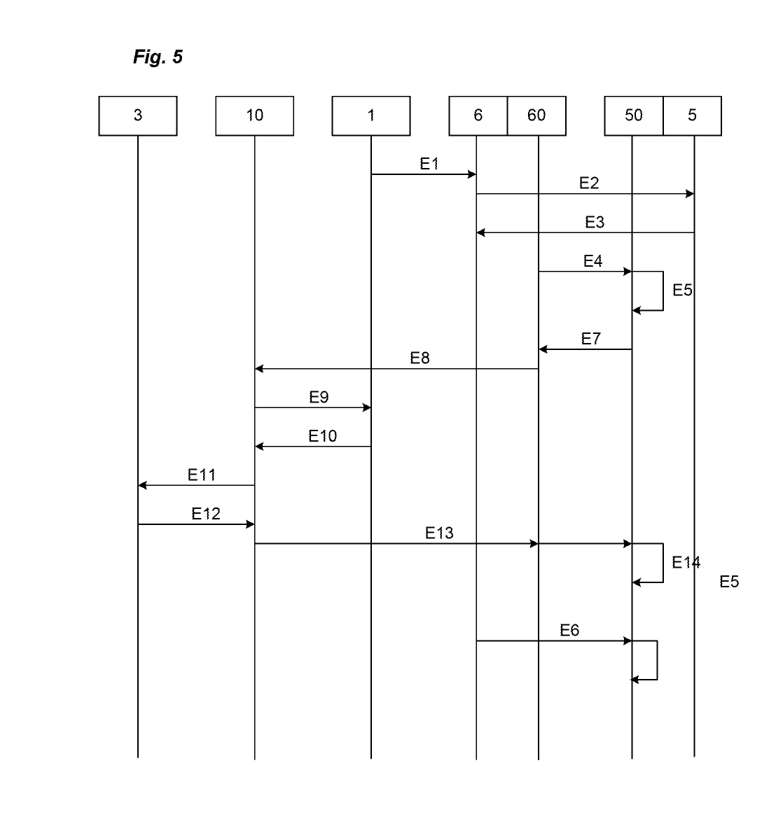

FIG. 5 illustrates the procedure implemented for the access by a user to a hardware entity 5 via a software entity 6. The procedure comprises the following steps:
E1: the user 1 sends a request to the software entity 6 with a view to carrying out an operation on a hardware entity 5,
E2: the software entity 6 requests the hardware entity 5 to establish a secure communications channel (for example under the TLS (for Transport Layer Security) protocol),
E3: the hardware entity 5 establishes a secure communications channel with the software entity 6,
E4: the software agent 60 of the software entity 6 signs the security token of the user 1 and sends it to the software agent 50 of the hardware entity 5,
E5: The verification module of the software agent 50 of the hardware entity 5 verifies the security token received.
   E6: if the security token is valid, the operation may be carried out on the hardware entity 5.
   if the security token is invalid:
      E7: the software agent of the hardware entity sends a response to the software agent of the hardware entity in order to inform it of the non-validity,
      E8: the software agent of the software entity requests an update of the security token to the security portal of the user,
      E9: the security portal requests the user to provide their identity data (identifier, password),
      E10: the user provides their identity data,
      E11: the security portal sends a request to the security server with a view to obtaining a security token, accompanied by the identity data for the user,
      E12: after reading the security database 4, the security server 3 sends the security token generated to the security portal,
      E13: the security portal transfers the security token to the software agent of the software entity which transfers it to the software agent of the hardware entity,
      E14: the verification module of the software agent of the hardware entity verifies the security token received for authentication,
      the analysis module of the software agent of the hardware entity verifies the access rights of the user,
      E6: if the new security token is valid, the operation may be carried out on the hardware entity.

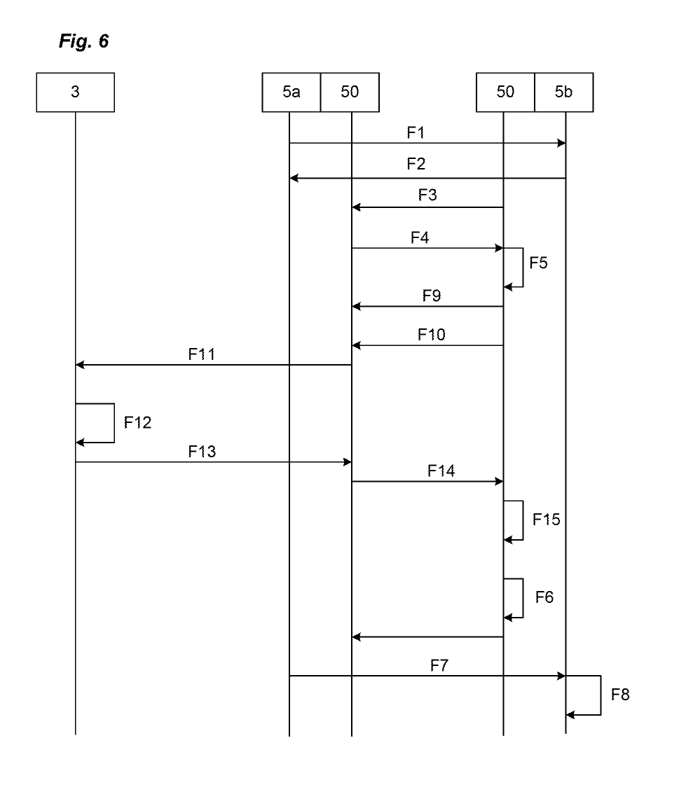

FIG. 6 illustrates the procedure established in order to allow a first hardware entity 5a to access a second hardware entity 5b. It comprises the following steps:
F1: the first hardware entity 5a requests the second hardware entity 5b to establish a secure communications channel (for example under the TLS (for Transport Layer Security) protocol),
F2: the second hardware entity 5b establishes a secure communications channel with the first hardware entity 5a,
F3: the software agent of the second hardware entity 5b sends a request to the software agent of the first hardware entity 5a with a view to obtaining its security token,
F4: the software agent of the first hardware entity 5a sends its security token to the software agent of the second hardware entity 5b,
F5: the verification module of the software agent of the second hardware entity 5b verifies the security token received,
   if the security token is valid:
      F6: the software agent of the second hardware entity analyzes the access rights of the first hardware entity,
      F7: if their access rights are validated, the first hardware entity 5a can send commands to the second hardware entity 5b,
      F8: the second hardware entity 5a authorizes the access of the first hardware entity 5a according to its access rights,
   F9: if the security token is invalid:
      F10: the software agent of the second hardware entity requests a new security token from the first hardware entity,
      F11: the software agent of the first hardware entity sends a request for the attention of the security server with a view to obtaining an update for its security token,
      F12: the security server generates a new security token using the XACML file, the security server date stamping and signing said file,
      F13: the security server sends the new security token to the software agent of the first hardware entity 5a,
      F14: the software agent of the first hardware entity transfers the security token to the software agent of the second hardware entity,
      F15: the verification module of the software agent of the second hardware entity verifies the new security token,
      F6: if the new security token is valid, the software agent of the second hardware entity analyzes the access rights of the first hardware entity,
      F7: if its access rights are validated, the first hardware entity 5a can send commands to the second hardware entity 5b,
      F8: the second hardware entity 5a authorizes the access of the first hardware entity 5a according to its access rights,

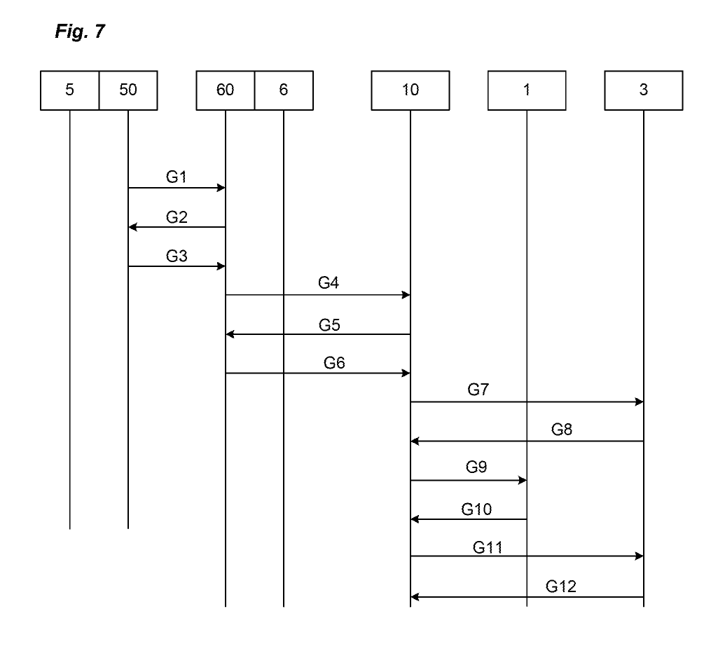

FIG. 7 illustrates the procedure for updating a security token belonging to a hardware entity. A software agent of a hardware or software entity that has received a valid security token may request whether the security token in its possession is indeed up to date. The procedure for verifying whether a security token is up to date is carried out on data representative of a compressed signature of the security token. Thus, only this data is sent by one entity to another. This procedure comprises the following steps:
G1: the agent of a first entity (hardware in FIG. 7) requests a verification of the security token received to the software agent of a second (software) entity present in the chain,
G2: if the software agent of the second entity concludes a difference, it sends back a response to the agent of the first entity,
G3: the software agent of the first entity requests the updated security token from the agent of the second entity,
G4: the software agent of the second entity sends a request to the security portal in order to find out whether the security token is up to date,
G5: after verification, if the security token is not up to date, the security portal sends a response to the software agent of the second entity indicating that the security token is not up to date,
G6: the software agent of the second entity requests the updated security token from the security portal,
G7: the security portal sends a request to the security server in order to find out whether the security token is up to date,
G8: after verification, if the security token is not up to date, the security server sends a response to the security portal indicating that the security token is not up to date,
G9: the security portal requests the user to input their identity data,
G10: the user inputs their identity data,
G11: the security portal sends a request for the attention of the security server with a view to obtaining a new security token,
G12: the security server responds to the security portal by sending a new security token to the security portal.

The solution of the invention thus offers numerous advantages, amongst which:
Allows the management of the identity data for each user or hardware entity in the industrial control system, in a centralized manner with a limited impact on the architectures of the existing products,
Allows the management of the authorizations and of the access rights of each user or hardware entity to each hardware or software entity of the system,
Renders secure the communications between the various entities of the system, by the direct exchange of the security tokens between these entities, without going via a central server, notably using techniques of asymmetric cryptography,
Covers all the levels of an industrial control system,
Access to multiple resources using a single authentication (or “Single Sign-On”).

Thus, by virtue of the security system of the invention, a user authenticates him/herself only once with the security server, then any authentication of the user by the various entities amounts to authenticating the security token that has been associated with them. Similarly, a user or a hardware entity, having a security token, has the capability of obtaining secured accesses to one or more hardware or software entities of the system, either directly or indirectly, on several levels.

1-4. (canceled)

5. A security system for an industrial control system that includes one or more hardware entities and/or one or more software entities accessible by at least one user via at least one security portal, the security system comprising:
a security database configured to store:
identity data associated with each user and hardware entity,
data for access rights to each hardware entity or software entity of the system, and
security tokens generated for each user and each hardware entity, each security token including a data signed by a security server and relating to identity of the user or of the hardware entity and the access rights data assigned to the user or to the hardware entity;
a security server comprising:
a module to verify identity data for a user or for a hardware entity in the security database,
a module to generate security tokens for each user or hardware entity identified in the security database,
a module to manage the identity data for each user and hardware entity stored in the security database, and
a module to manage the access rights data stored in the security database;
each hardware entity or software entity comprising a software agent comprising:
a module to verify each security token received coming from a security portal, from a software entity or from another hardware entity,
a module to analyze the access rights of the user, of another software entity, or of another hardware entity, and
a module to receive security tokens configured to receive and store each token received and to sign the security token received from a security portal or from a first hardware entity and to transfer the signed token to a second hardware or software entity to which the security portal or the first hardware entity wishes to gain access.

6. A system according to claim 5, wherein each software agent comprises a module for managing cryptographic keys configured to generate, exchange, store, use, and replace cryptographic keys needed to sign or to decrypt a security token.

7. A system according to claim 5, wherein each software agent comprises one or more cryptographic libraries.

8. A system as claimed in claim 5, wherein the software agent of a hardware entity comprises an authentication module configured to send the identity of the hardware entity to the security server to receive a security token from the security server.
